(19) United States
(12) Patent Application Publication
(10) Pub. No.: US 2026/0336670 A1
(43) Pub. Date: Oct. 29, 2026

(54) AUTONOMOUS STATION OF A CABLE TRANSPORT SYSTEM WITH AUTONOMOUS RESET FUNCTION

(71) Applicant: LEITNER S.P.A., Vipiteno (IT)

(72) Inventor: Guenter Tschinkel, Vipiteno (IT)

(21) Appl. No.: 19/659,721

(22) Filed: Apr. 27, 2026

(30) Foreign Application Priority Data
Apr. 29, 2025 (IT) 102025000009507

(51) Int. Cl. B61B 1/02; B61B 7/04; B61L 27/53; G08B 7/06

(52) U.S. Cl. CPC B61B 1/02; B61B 7/04; B61L 27/53; G08B 7/06

(57) ABSTRACT

A station for a cable transportation system with at least a transport unit. The station includes at least one barrier able to be opened from a closed position and an alarm sensor configured to detect the opening of the barrier. In case of the opening of the barrier, the alarm sensor transmits an alarm signal to a control unit configured to stop or reduce the speed of the transport units. The barrier includes an actuator device configured to reset the barrier to the closed position and an autonomous actuating system of the actuator device of the barrier enables the barrier to return to the closed position without requiring any remote or local action by operating personnel.

### PRIORITY CLAIM

This application claims the benefit of and priority to Italian Patent Application No. 102025000009507, filed on Apr. 29, 2025, the entire contents of which is incorporated by reference herein.

### TECHNICAL FIELD

This disclosure relates to a cable transportation system with at least a transport unit in motion between two terminal stations where embarking and/or disembarking takes place. When certain hazardous conditions occur in the station (e.g., if a passenger enters a hazardous area or if something gets stuck in the door of the transport unit), the system commands a slowdown or temporary stop of the transport units. In this context, the present disclosure addresses the problem of how to implement an autonomous restoration of normal system functionality once the reason for the slowdown or temporary stop has been resolved.

### BACKGROUND

A cable transportation system is a system for transporting passengers and/or sports equipment and/or materials that are transported in transport units between two terminal stations at the ends of the system. The passengers disembark and/or embark at the terminal stations, as well as at any intermediate stations (if present). These systems are defined as cable systems because at least outside the stations the transport units are moved by a hauling cable that is in motion between the terminal stations. The cable is looped between terminal stations and there is a special motorised pulley within a station. Within the stations, the transport units advance uncoupled from the cable and are moved by other devices, such as motorized rubberized wheels. This allows the transport units to advance relatively more slowly in stations than the transport units travelling outside the stations, thus facilitating the embarking and/or disembarking of passengers. Cable systems can be of the aerial type (i.e., with a single cable that performs the double function of supporting and hauling cable or with at least one supporting and one hauling cable), or of the terrestrial type (e.g., with tracks on which the transport units run).

As mentioned above, disembarking and embarking from transport units takes place at the station. For safety reasons, safety barriers in the station prevent passengers from reaching hazardous areas. In aerial systems with cabins, certain hazardous areas are at the entrance and exit of the station. There may also be other hazardous areas, such as the engine room, areas containing moving mechanical parts, and areas where relatively high-voltage electricity is present. Safety barriers are provided with an outer profile that essentially corresponds to the outer profile of the transport units so that when the transport unit passes the barrier there is only a relatively small clearance between the two profiles. These barriers may be movable (i.e., able to be opened) because station personnel may sometimes be required to go beyond the barrier. In addition, the opening of the barrier means it is not destructive or hazardous for the barrier itself to impact with anything that may be stuck protruding in the door from the transport unit. This event, as well as the accidental opening of the barrier by a passenger, generates a relatively risky situation that must be detected to be able to intervene promptly. To this end, the safety barrier may be equipped with a sensor that can detect its opening and generate an alarm signal. This alarm signal can be directly transmitted to the system's control unit that acts autonomously to slow down and/or stop the transport units, or it can be transmitted to the station personnel who act manually. Once the problem that caused the safety barrier to open has been resolved, the barrier must be returned to its original or closed position before the system can be restored.

Resetting the barrier is performed manually by station personnel. According to EP4139180, the barrier reset can be operated remotely by equipping barriers with remotely controllable actuators. In this way, manual intervention on site is not required and personnel can be deployed remotely (e.g., personnel at one terminal station can command the reset of the barrier installed at the other terminal station).

In addition to the safety barriers described above, which divide the station into zones with different risk levels, other types of barriers include control barriers may also be present in the station. These control barriers do not divide the station into zones with different risk levels, but are used to check whether the transport unit is in the correct, intended configuration at a specific point. For example, if the transport unit is a cabin, a control barrier is installed for the cabin door status (i.e., a barrier that verifies that the door is actually closed) at a specific point (usually before the station exit safety barrier). If, at the control point, the cabin door is not closed, the control barrier is forced to move. Conversely, if the cabin door is correctly closed at the control point, the control barrier remains in its position as the unit passes. The control barriers are also equipped with a sensor capable of detecting movement and generating an alarm signal. This alarm signal can be transmitted directly to the system's control unit, which acts autonomously to slow down and/or stop the transport units, or the alarm signal can be transmitted to station staff who intervene manually.

### SUMMARY

According to certain embodiments, the present disclosure is directed to a station for a cable transportation system, a cable transportation system (e.g., an aerial cable transportation system) and a method of operating a cable transportation system. In certain of these embodiments, the station includes a barrier configured to be opened from a closed position, the barrier comprising an actuator device configured to reset the barrier to the closed position, wherein an autonomous actuating system of the actuator device enables the barrier to return to the closed position without requiring any remote action by operating personnel and without requiring any local action by operating personnel. In these embodiments, the station also includes an alarm sensor configured to detect an opening of the barrier, wherein responsive to a detected opening of the barrier, the alarm sensor transmits an alarm signal to a control unit configured to cause at least one of a reduction in speed of the transport unit, a stoppage of the transport unit, a generation of a visual alarm signal and a generation of an audible alarm signal.

In certain embodiments, the station is for a cable transportation system with at least a transport unit in which zero, one or more passengers are transported in transport units and perform boarding and/or disembarking at stations. The transport units include gondolas (e.g., gondola lifts), chairlifts or a combination of both (i.e., ‘telemix’ systems). In the station, at least one safety barrier is provided to divide the station into different areas and/or a control barrier is provided to verify the status of the transport unit at a checkpoint. The barrier(s) of these embodiments can be opened or moved from a closed position or first position and an alarm sensor is configured to detect the opening of the barrier (that is, detect a different barrier position from the closed position). In the case of control barriers, it should be appreciated that these barriers do not divide the station into zones of differing risk; it is therefore more accurate to refer to the ‘movement of the barrier’rather than its ‘opening’.

In certain embodiments, if the barrier is opened, the alarm sensor generates an alarm signal and transmits the alarm signal to a control unit. In different examples, the control unit reduces the speed of the transport units, stops the transport units and/or emits a visual alarm signal and/or an audible alarm signal on-site at the station and/or remotely via a portable device. In these embodiments, once the problem that caused the barrier to open has been resolved, the barrier must be reset (i.e., returned to the closed position).

According to certain aspects of this disclosure, the resetting of the barrier (e.g., safety barrier and/or control barrier) is provided for in a way that does not require the presence and intervention of either on-site or remote personnel. For this purpose, the barrier is equipped with an actuator device configured to return the barrier to the closed position. Additionally, there is an autonomous actuating system for the barrier actuator device. In this way, the barrier returns to the closed position without requiring any remote or local action on the part of the station personnel. According to the present disclosure, the absence of “any action” means the absence even of a simple activation command that could be executed via a portable device or a control panel. It should be appreciated that this autonomous reset functionality of the barrier does not mean that the barrier cannot also be closed manually or that the actuator device cannot provide on-site operation under the command of the station personnel.

According to certain embodiments of this disclosure, the autonomous actuating system of the barrier actuator device comprises a timer device directly integrated into the actuator device and configured to actuate the actuator device of the barrier after a predetermined time interval starting from the detection of the opening of the barrier by the alarm sensor. In this case, the alarm sensor transmits the signal not only to the control unit but also to the timer, which is in turn configured to operate the actuator device.

In certain embodiments, the timer device is configured to make subsequent closing attempts after the first attempt in the event that the alarm sensor still detects the opening of the barrier (continuous monitoring of the alarm sensor). Alternatively, a remote control command is provided whereby an operator can pause the timer (however, this remote pause command does not constitute a command to operate the barrier, as once the pause phase has ended, the barrier operates entirely autonomously in accordance with the present disclosure).

According to certain embodiments of this disclosure, the autonomous reset (i.e., the autonomous actuation of the barrier actuator) is performed not on a temporal basis but only when there are no longer any impediments to the closing of the barrier. In these embodiments, the autonomous actuating system of the barrier actuator device includes a reset sensor configured to check whether or not there are any impediments to the barrier's closure. Only if there are no impediments to closure is it able to generate and transmit a reset signal to the barrier to actuate its actuator device. In certain such embodiments, the reset sensor is in the form of an image acquisition device (e.g., a camera) in a position to acquire images of the barrier and the environment near the barrier. In these embodiments, the camera is connected to a processing unit configured to analyse the images acquired and to transmit the reset signal to the barrier only if there is no impediment to its closure. According to certain embodiments of the disclosure, the reset sensor and alarm sensor are the same image acquisition device such that upon optically detecting the opening of the barrier, the processing unit transmits the alarm signal to the control unit to slow down and/or stop the transport units. Subsequently, once optically detecting the absence of impediments to closing, the processing unit transmits the reset signal to the actuator device of the barrier to close the barrier.

In certain embodiments, the actuator device is configured to autonomously bring the barrier to maximum opening before closing the barrier when the alarm sensor detects the initial opening step. In this sense, the barrier is movable between two end stops at closing and maximum opening.

In certain embodiments, the cable transportation system, such as an aerial cable transportation system for transporting passengers, includes one or more stations for embarking and/or disembarking; at least a transporting unit; at least one cable; and a control unit to control the speed of the transport units. In these embodiments, at least one of the stations in the system is a station as described above with at least one barrier which offers autonomous reset functionality.

In certain embodiments, the present disclosure is embodied as an operation method of a cable transportation system with a transport unit in which zero, one or more passengers are transported in transport units and/or perform boarding and disembarking at stations. The method of these embodiments includes (a) providing a station with at least one safety or control barrier that can be opened from a closed position; (b) detecting the opening of the barrier (i.e., monitoring the barrier to promptly detect its opening); (c) in the event of a barrier opening, stopping and/or reducing the speed of the transport units; (d) autonomously closing the barrier (i.e., bringing the barrier to the closed position) without requiring any remote or local action by the operating personnel; and (e) restarting or increasing the speed of the transport units.

In certain such embodiments, autonomously closing the barrier is performed autonomously after a predetermined time interval from the detection of the barrier opening. In certain such embodiments, between autonomously closing the barrier and restarting or increasing the speed of the transport units, a verification of the barrier closure is provided and if the barrier closure is not verified, autonomously closing the barrier is repeated. In certain embodiments, before autonomously closing the barrier, the method includes checking whether there are impediments to barrier closure and then autonomously closing the barrier only if there are no impediments.

In certain embodiments, detecting the opening of the barrier and checking whether there are impediments to the closing of the barrier before closing the barrier are performed by the same image acquisition device connected to a processing unit. In certain embodiments, upon detection of the opening, the method includes completely opening the barrier to the opening end stop.

### BRIEF DESCRIPTION OF THE DRAWINGS

For a better understanding of this disclosure, an embodiment thereof will now be described, purely by way of a non-limiting example, with reference to the accompanying drawings, wherein:

FIG. 1 is a schematic view of an aerial cable transportation system that may be improved in accordance with this disclosure;

FIGS. 2 and 3 are schematic views of the station in FIG. 1; and

FIG. 4 is a schematic view of a portion of the station in FIG. 2 in which the interaction between a barrier and a transport unit is schematised.

### DETAILED DESCRIPTION

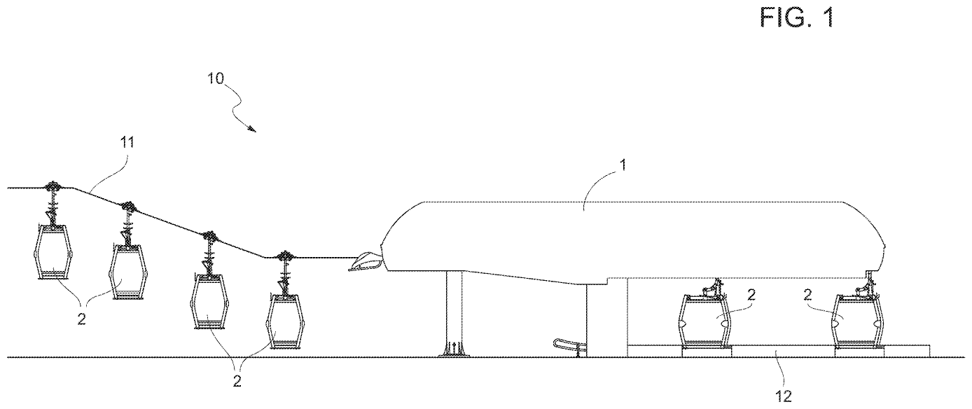

FIG. 1 is a schematic view of a portion of an aerial cable transportation system that may be improved in accordance with this disclosure. This system is generally indicated in FIG. 1 with reference number 10 and comprises multiple transport units in the form of cabins 2 that are moved by a hauling cable 11 between two terminal stations 1 (only one station 1 is shown in FIG. 1). In addition to the terminal stations, there may also be intermediate stations. In the stations, the passengers embark and/or disembark, and reference number 12 identifies a transit platform in the station for passengers. While described in relation to aerial cable transportation systems, the station of the present disclosure is applicable to stations of terrestrial cable systems.

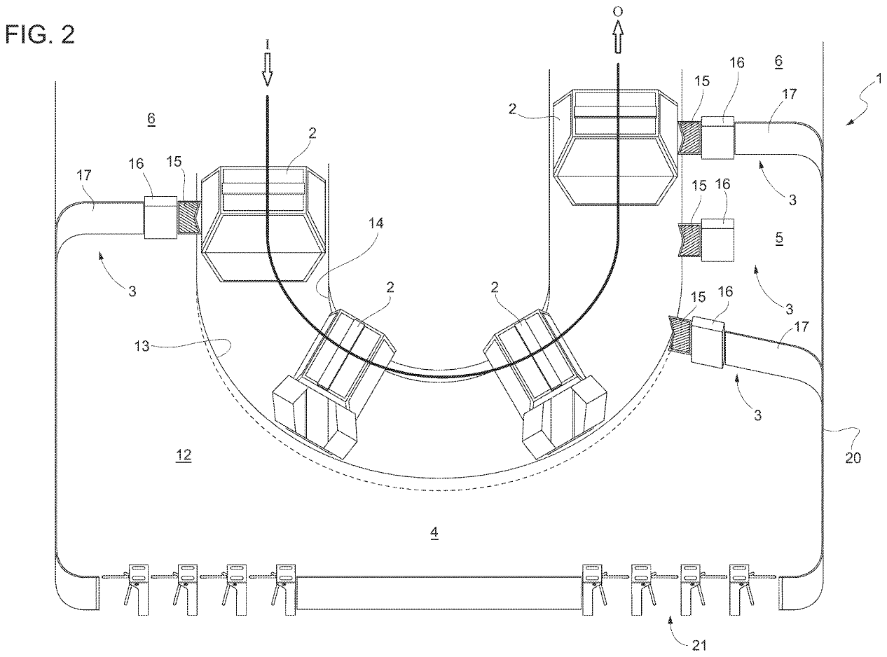

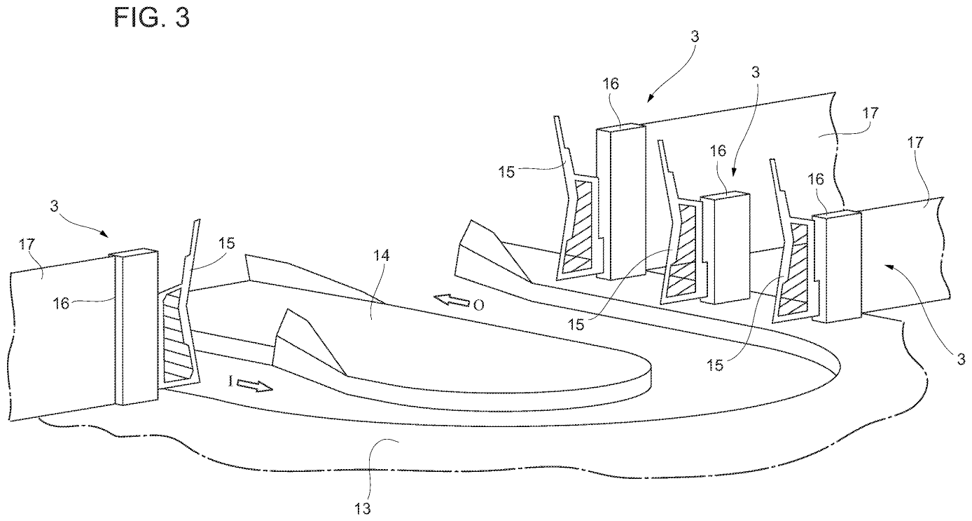

FIGS. 2 and 3 are schematic views of the station in FIG. 1. In these figures, it can be seen that the station 1 is a station in which the cabins 2 make a U-shaped path between an entry I and an exit O without ever stopping. In the station, the platform 12 comprises an inner edge that acts as a first side 13 for a first lower portion of the cabins (eventually equipped with a footboard) so that passengers pass directly from the cabin 2 to the platform 12 and vice versa. There is also a second opposite side 14 configured to contain and guide the cabins 2, which then advance between the aforementioned sides 13 and 14. Reference 20 identifies the fixed perimeter structure that defines the boundary between Station 1 and the area outside Station 1. At least one section of this fixed structure is fitted with turnstiles 21 for passengers to enter and exit the station. There are safety barriers 3 at the station 1 that divide the platform 12 into different and separate areas (indicated in FIG. 2 with reference numbers 4—safe area—5—hazardous area—and 6 outside area). The purpose of these safety barriers 3 is to prevent passengers from entering hazardous areas.

Along the route taken by the transport units, there is a first safety barrier 3 at the station entrance, separating the external area 6 from the safe area 4; a second safety barrier 3, separating the safe area 4 from the hazardous area 5; and a third safety barrier 3 at the station exit, separating the hazardous area 5 from the external area 6. When a unit 2 transits at the barriers 3, the edges of the transport units 2 and barriers are in a relatively very close position. For this purpose, the corresponding edges of the barriers 3 and cabins 2 are shaped to complement each other so that at the barriers 3 there is relatively no free space (i.e., only a relatively small gap) between the barrier 3 and cabin 2 in transit. In this way, if there were something stuck in the door of the cabin 2 or if the doors were not properly closed, an impact would be generated against the barrier 3. To prevent this impact from being destructive, and to enable station personnel to move beyond the barrier 3 if necessary, each safety barrier 3 comprises a movable portion 15 essentially facing the passing transport unit, a fixed portion 16 supporting the movable section and an extension 17 that connects the fixed section 16 to the station's fixed perimeter structure 20. In this way, to move from one area to another, a passenger must open (i.e., move) the movable section 15 of the safety barrier 3. The movable part 15 operates as a gate that in the closed position is essentially orthogonal to the forward direction of the cabins 2 and has the aforementioned outer edge complementary to the edge of the cabins 2. The opposite edge of the movable portion 15 is coupled to the fixed part 16 so that the movable portion revolves around a vertical axis. Thus, the opening of the barrier 3 occurs when the movable part 15 is rotated with respect to the fixed part 16. It should be appreciated that the number and position of the safety barriers 3 may vary from station to station, also their geometry and the way they are integrated into the station to divide the station into different zones may vary. In this illustrated design, a control barrier 3 is also visible in hazard zone 5. This control barrier differs from the safety barriers described previously because the control barrier does not divide the station into zones of differing risk (i.e., the control barrier lacks the extension 17 that connects it to the perimeter structure 20) but is intended to monitor the status of the transport unit at a specific point. For example, in hazardous zone 5, which precedes the external zone 6, the doors must be closed. As such, a purpose of the control barrier of this example is to verify that the cabin doors 2 are correctly closed.

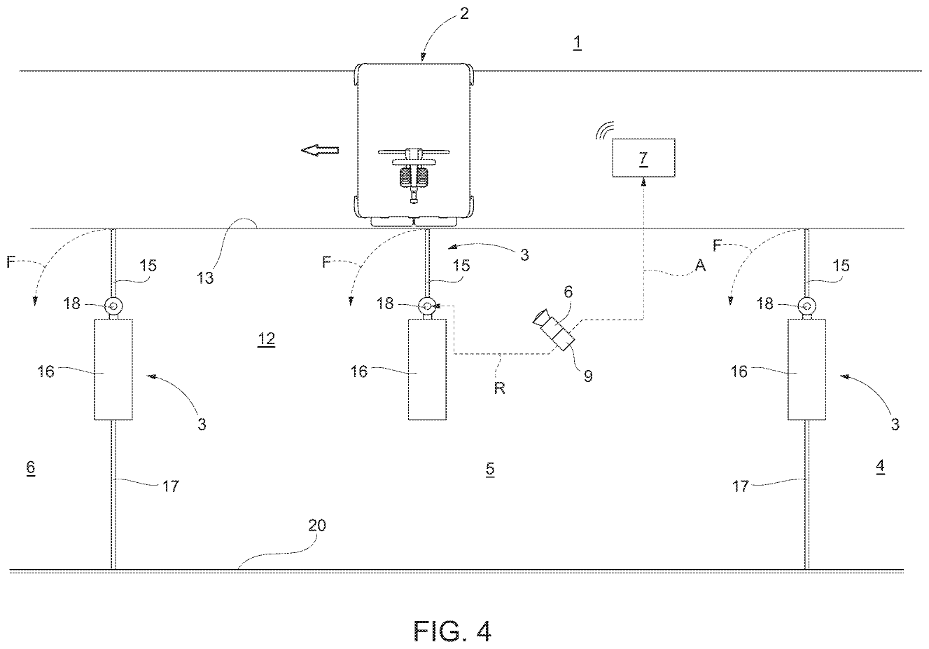

FIG. 4 is a schematic view of a portion of the station in FIG. 2 in which it has been schematically depicted a cabin 2 in transit at a control barrier 3 as described above and located in Zone 5. This figure exemplifies the new autonomous reset function of the barrier 3 after its opening (schematically depicted with the arrow F). The example in FIG. 4 includes a camera 6 (as an example of an image acquisition device) placed in the station in a position to capture images of the barrier 3 and the environment close to the barrier 3 (such as the cabin 2 passing through). The camera 6 is connected to a processing unit 9 that analyzes the images captured by the camera 6 and is able to detect if the barrier 3 is open. In this case, the processing unit 9 generates an alarm signal A that is transmitted to the control unit 7, which commands the cabins 2 (both those in the station and those outside the station) to stop or slow down. The camera 6 continues to monitor the barrier 3 and thus the processing unit 9, which analyzes the images captured by the camera 6, is able to verify, over time, whether or not the problem that caused the barrier 3 to open has been resolved. In these embodiments, only when the processing unit 9 verifies that there is no impediment to closing the barrier 3, does the unit 9 itself generate a reset signal R that is transmitted to a barrier actuator device 18 configured to return the barrier to the closed position. The closure of the barrier 3 therefore takes place without any intervention by station personnel either on site or remotely. The automatic operation described for the control barrier can be replicated for the safety barriers as well.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Lastly, it is clear that modifications may be made to the disclosure described and illustrated herein, and variations produced thereto, without departing from the scope of this disclosure, as set forth in the claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

The invention is claimed as follows:

1. A station of a cable transportation system comprising a transport unit, the station comprising:
a barrier configured to be opened from a closed position, the barrier comprising an actuator device configured to reset the barrier to the closed position, wherein an autonomous actuating system of the actuator device enables the barrier to return to the closed position without requiring any remote action by operating personnel and without requiring any local action by operating personnel; and
an alarm sensor configured to detect an opening of the barrier, wherein responsive to a detected opening of the barrier, the alarm sensor transmits an alarm signal to a control unit configured to cause at least one of a reduction in speed of the transport unit, a stoppage of the transport unit, a generation of a visual alarm signal and a generation of an audible alarm signal.

2. The station of claim 1, wherein the autonomous actuating system of the actuator device comprises a timer device configured to actuate the actuator device of the barrier after a predetermined time interval from a detection, by the alarm sensor, of the opening of the barrier.

3. The station of claim 2, wherein the timer device is configured to make successive closing attempts when the alarm sensor detects the opening of the barrier after a first reset attempt.

4. The station of claim 2, wherein the timer device is configured to enter and exit a pause state in response to at least one of a command issued by an operator on-site at the station and a command issued by an operator remote from the station.

5. The station of claim 1, wherein the autonomous actuating system of the actuator device comprises a reset sensor configured to determine whether there are any impediments to closing the barrier and responsive to the determination being that there are no impediments to closing the barrier, transmit a reset signal to the actuator device of the barrier.

6. The station of claim 5, wherein the reset sensor comprises an image acquisition device connected to a processing unit and configured to analyze an image acquired and transmit the reset signal to the actuator device of the barrier.

7. The station of claim 5, wherein the reset sensor and the alarm sensor comprise a same image acquisition device such that responsive to the detected opening of the barrier, a processing unit:
transmits the alarm signal to the control unit to cause one of the slow down of the transport unit and the stoppage of the transport unit, and then
responsive to the determination being that there are no impediments to closing the barrier, transmits the reset signal to the actuator device of the barrier to close the barrier.

8. The station of claim 1, wherein the actuator device is configured to bring the barrier to a maximum opening before closing the barrier.

9. The station of claim 1, wherein the barrier comprises at least one of:
a safety barrier configured to divide the station into different areas, and
a control barrier configured to monitor a status of the transport unit at a control point within the station.

10. A cable transportation system comprising:
a transport unit;
a cable;
a control unit configured to control a speed of the transport unit; and
a station configured to enable at least one of passenger embarkation and passenger disembarkation, the station comprising:
a barrier configured to be opened from a closed position, the barrier comprising an actuator device configured to reset the barrier to the closed position, wherein an autonomous actuating system of the actuator device enables the barrier to return to the closed position without requiring any remote action by operating personnel and without requiring any local action by operating personnel, and
an alarm sensor configured to detect an opening of the barrier, wherein responsive to a detected opening of the barrier, the alarm sensor transmits an alarm signal to a control unit configured to cause at least one of a reduction in the speed of the transport unit, a stoppage of the transport unit, a generation of a visual alarm signal and a generation of an audible alarm signal.

11. A method of operating a cable transportation system with a transport unit, the method comprising:
detecting, at a station, an opening of a barrier from a closed position;
causing at least one of a reduction in a speed of the transport unit and a stoppage of the transport unit;
autonomously closing the barrier without requiring any remote action by operating personnel and without requiring any local action by operating personnel; and
at least one of causing a restart of the transport unit and causing an increase in the speed of the transport unit.

12. The method of claim 10, wherein autonomously closing the barrier occurs after a predetermined time interval from the detection of the opening of the barrier.

13. The method of claim 12, further comprising verifying the barrier is autonomously closed prior to the at least one of causing the restart of the transport unit and causing the increase in the speed of the transport unit and responsive to the barrier not being verified as closed, repeating autonomously closing the barrier.

14. The method of claim 12, further comprising enabling an operator to cause a pausing and resumption of autonomously closing the barrier.

15. The method of claim 10, further comprising, before autonomously closing the barrier, determining whether there are impediments to a barrier closure and autonomously closing the barrier responsive to the determination being that there are no impediments.

16. The method of claim 15, wherein determining whether there are impediments to the barrier closure comprising an image acquisition device connected to a processing unit analyzing an acquired image.

17. The method of claim 16, wherein detecting the opening of the barrier and determining whether there are impediments to the closing of the barrier closure are performed by the same image acquisition device and the same processing unit.

18. The method of claim 12, further comprising fully opening the barrier after detecting the opening of the barrier.
